(19) United States
(12) Patent Application Publication
(10) Pub. No.: US 2019/0217715 A1
(43) Pub. Date: Jul. 18, 2019

(54) EV CHARGING PROJECTOR

(71) Applicant: Ford Global Technologies, LLC, Dearborn, MI (US)

(72) Inventors: Erik J. Christen, Royal Oak, MI (US); Yang Yang, Belleville, MI (US); Mahmoud Abdelhamid, Canton, MI (US)

(21) Appl. No.: 15/871,721

(22) Filed: Jan. 15, 2018

(51) Int. Cl. B60L 11/18; G02B 27/18

(52) U.S. Cl. CPC B60L 11/1835; G02B 27/18; B60L 11/1846; B60L 11/1848

(57) ABSTRACT

An electric vehicle (EV) charge system includes a plug, a camera, a projection unit, and a controller. The controller may be configured to, responsive to receiving a charge request, activate the camera to capture an image of a vehicle, and project onto the vehicle guidance information associated with the plug based on a vehicle type and relative vehicle location identified from the image.

### TECHNICAL FIELD

This disclosure relates to an electric vehicle charge system that is configured to visually project vehicle and charging information.

### BACKGROUND

Electric vehicles have increased in popularity creating a demand for electric vehicles. To meet the demand, many automotive manufacturers are developing multiple electric vehicle models. Often different automotive manufacturers adopt different standards associated with their vehicles and in some instances different standards across different models. Along with using charging receptacles of different standards, the automotive manufacturers may place the charging receptacle in different locations on the vehicle. For example, some of the vehicle receptacle locations include front grill, front driver quarter panel, rear driver quarter panel, integrated with rear lighting, integrated with front lighting, rear face of the vehicle. And the different standards adopted by some manufacturers include CHAdeMO, GB/T, COMBO1, COMBO2 that may operate at different levels, such as Level 1, Level 2, or DC Fast Charge. These electric vehicles are being deployed in short term lease areas including dealer leased vehicles, rental vehicles, shared vehicles, and corporate fleets.

### SUMMARY

An electric vehicle (EV) charge system includes a plug, a camera, a projection unit, and a controller. The controller may be configured to, responsive to receiving a charge request, activate the camera to capture an image of a vehicle, and project onto the vehicle guidance information associated with the plug based on a vehicle type and relative vehicle location identified from the image.

An alignment method for an electric vehicle charge station performed by a controller includes, responsive to a charge request, activating a camera to capture an image of a vehicle, and causing a projection unit to project onto the vehicle guidance information associated with a plug of the charge station based on a vehicle type and relative vehicle location identified from the image.

A charge station for an electric vehicle includes a plug, a projection unit, and a controller. The controller may be configured to, responsive to receiving a charge request and identification of a relative location of the vehicle to the charge station, cause the projection unit to project onto the vehicle guidance information associated with the plug.

### BRIEF DESCRIPTION OF THE DRAWINGS

FIG. 1 is a diagram of a hybrid electric vehicle illustrating typical charging and energy storage components.

FIG. 2 is a top view illustration of an electric vehicle charger capturing an image and projecting information onto a hybrid electric vehicle.

FIG. 3 is a top view illustration of an electric vehicle charger projecting information onto a hybrid electric vehicle.

FIG. 4 is a perspective view illustration of information projected from an electric vehicle charger onto a hybrid electric vehicle.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Charging a plug-in electric vehicle (PEV or PHEV) is a task that is often taken for granted. However, data from actual user experience data indicate that successfully completing a charge event can be problematic. This is especially true when a customer moves from one PEV to another PEV that they are less familiar with. The customer may not be sure if they plugged the cord in correctly, and if charging has successfully been started or completed. They may not even be aware of what type of plug to use or if they are using the correct charger resulting in a poor user experience for many customers.

Here systems and methods are disclosed for providing feedback, related to coupling and charging, to the customer to enhance the user experience of charging. In one embodiment, the system includes a light/image projection system that may be housed in a charge plug, or integrated with the electrical vehicle charge system. A charge request initiates the operation, the charge request may include depression of a button or switch on a charge station plug or a charge station, it may be detection of a removal of the plug from a charge station cradle, via a cradle/plug switch or sensor, or it may be activation by a controller (e.g., a wireless or wired reception of payment information, or other authorization of power distribution). In the instant when the projection unit is in the cord set head (plug), when the cord is pointed at the vehicle, a heads-up display (HUD) is projected onto the vehicle. This projection will contain charge event information, based on the vehicle and/or charge port characteristics. The charge event information includes a location of the receptacle, a type of the receptacle, etc. For example, in one embodiment, default information is projected from the charge cord onto the vehicle. The default information includes a type of charge cord/system (e.g. CHAdeMO) and an available power (e.g., Level II—6.6 kW).

In another embodiment, a charge cord and vehicle communicate via a wireless network. The wireless network may be a cellular network, a mobile radio network, a wireless local area network such as 802.x (e.g., Wi-Fi, Super Wi-Fi, Bluetooth, etc.), a vehicle to infrastructure (V2X, V2I) network (e.g., dedicated short-range communications (DSRC)), an Infrared Data Association (IrDA) device, or other wireless system. The charger and vehicle communicate wirelessly over a network (modem/device in the vehicle with a modem/device in the charge station) to provide additional vehicle specific information to project. The vehicle specific information may include charger-to-port compatibility, charge port location, a traction Battery state of charge (SOC), battery temperature, a projected departure time, and an estimated charge time based on the SOC.

In another embodiment, an image capture device (e.g., a camera), that may be located in the charge station or in the head (plug) of the charge cord, is used to determine a type of vehicle, and a relative location of the vehicle. Upon examining or parsing an image from the camera, a controller may determine what charge system is equipped in the vehicle by identifying a vehicle manufacturer and a vehicle type/make/model. In some instances, the controller may, upon parsing and analyzing the image, be able to detect a vehicle model year. With the manufacturer, make, model, and model year, the controller may generate an image to be projected by the projection unit. The image may include guidance information such as arrows or indicators that point towards a location of the receptacle, or an outline of the vehicle with an accentuated location of the receptacle. The projection unit may then project the information accordingly (e.g., guidance information, compatibility, etc.).

In another embodiemnt, when the charge cord/plug is disconnected from the vehicle, responsive to the customer pointing it casually at the vehicle, the controller via the camera would identify vehicle characteristics including the manufacturer, make, model, and year, or charge port characteristics including type, and charge capability based on image recognition. Once the controller identifies the charger type of the vehicle, the controller would assess compatability and output an indication according. For example, if the vehicle charge port is a CHAdeMO type port and the charger is a COMBO1 (US), the controller may cause an error message (e.g., red light projected from the projection unit, illuminate a ring around the recptacle via wireless communication, project a message to inform the customer of the error. The controller may then identify the closest complient charger (a CHAdeMO charge station) and project a image/map/text onto the vehicle, or wirelessly transmit direction to the vehicle to be displayed on an in-vehicle navigation system.

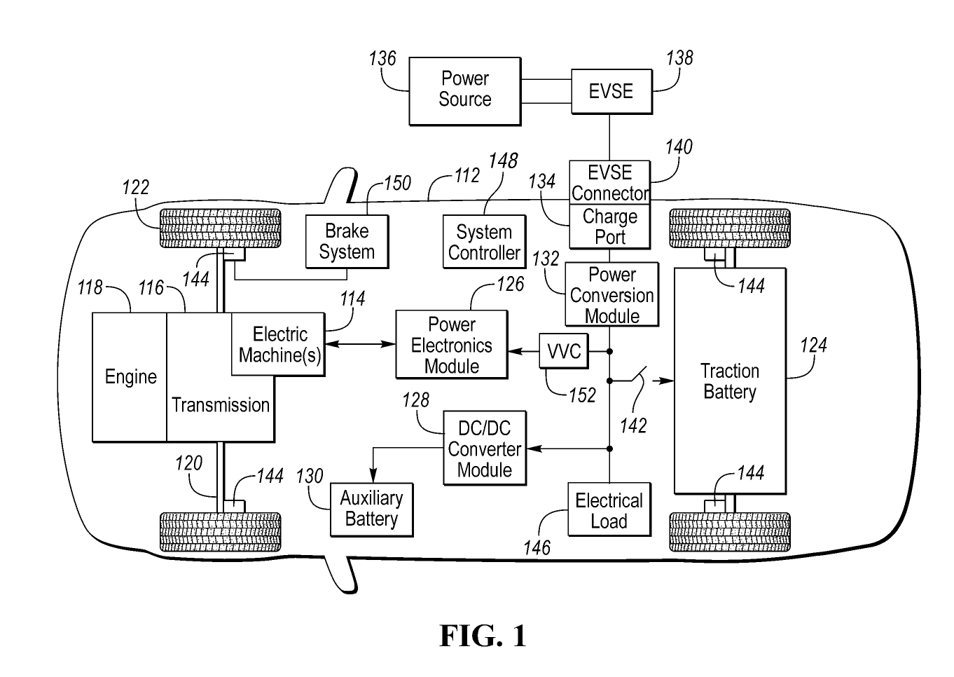

FIG. 1 depicts an electrified vehicle 112 that may be referred to as a plug-in hybrid-electric vehicle (PHEV). A plug-in hybrid-electric vehicle 112 may comprise one or more electric machines 114 mechanically coupled to a hybrid transmission 116. The electric machines 114 may be capable of operating as a motor or a generator. In addition, the hybrid transmission 116 is mechanically coupled to an engine 118. The hybrid transmission 116 is also mechanically coupled to a drive shaft 120 that is mechanically coupled to the wheels 122. The electric machines 114 can provide propulsion and deceleration capability when the engine 118 is turned on or off. The electric machines 114 may also act as generators and can provide fuel economy benefits by recovering energy that would normally be lost as heat in a friction braking system. The electric machines 114 may also reduce vehicle emissions by allowing the engine 118 to operate at more efficient speeds and allowing the hybrid-electric vehicle 112 to be operated in electric mode with the engine 118 off under certain conditions. An electrified vehicle 112 may also be a battery electric vehicle (BEV). In a BEV configuration, the engine 118 may not be present. In other configurations, the electrified vehicle 112 may be a full hybrid-electric vehicle (FHEV) without plug-in capability.

A traction battery or battery pack 124 stores energy that can be used by the electric machines 114. The vehicle battery pack 124 may provide a high voltage direct current (DC) output. The traction battery 124 may be electrically coupled to one or more power electronics modules 126. One or more contactors 142 may isolate the traction battery 124 from other components when opened and connect the traction battery 124 to other components when closed. The power electronics module 126 is also electrically coupled to the electric machines 114 and provides the ability to bi-directionally transfer energy between the traction battery 124 and the electric machines 114. For example, a traction battery 124 may provide a DC voltage while the electric machines 114 may operate with a three-phase alternating current (AC) to function. The power electronics module 126 may convert the DC voltage to a three-phase AC current to operate the electric machines 114. In a regenerative mode, the power electronics module 126 may convert the three-phase AC current from the electric machines 114 acting as generators to the DC voltage compatible with the traction battery 124.

The vehicle 112 may include a variable-voltage converter (VVC) 152 electrically coupled between the traction battery 124 and the power electronics module 126. The VVC 152 may be a DC/DC boost converter configured to increase or boost the voltage provided by the traction battery 124. By increasing the voltage, current requirements may be decreased leading to a reduction in wiring size for the power electronics module 126 and the electric machines 114. Further, the electric machines 114 may be operated with better efficiency and lower losses.

In addition to providing energy for propulsion, the traction battery 124 may provide energy for other vehicle electrical systems. The vehicle 112 may include a DC/DC converter module 128 that converts the high voltage DC output of the traction battery 124 to a low voltage DC supply that is compatible with low-voltage vehicle loads. An output of the DC/DC converter module 128 may be electrically coupled to an auxiliary battery 130 (e.g., 12V battery) for charging the auxiliary battery 130. The low-voltage systems may be electrically coupled to the auxiliary battery 130. One or more electrical loads 146 may be coupled to the high-voltage bus. The electrical loads 146 may have an associated controller that operates and controls the electrical loads 146 when appropriate. Examples of electrical loads 146 may be a fan, an electric heating element and/or an air-conditioning compressor.

The electrified vehicle 112 may be configured to recharge the traction battery 124 from an external power source 136. The external power source 136 may be a connection to an electrical outlet. The external power source 136 may be electrically coupled to a charger or electric vehicle supply equipment (EVSE) 138. The external power source 136 may be an electrical power distribution network or grid as provided by an electric utility company. The EVSE 138 may provide circuitry and controls to regulate and manage the transfer of energy between the power source 136 and the vehicle 112. The external power source 136 may provide DC or AC electric power to the EVSE 138. The EVSE 138 may have a charge connector 140 for plugging into a charge port 134 of the vehicle 112. The charge port 134 may be any type of port configured to transfer power from the EVSE 138 to the vehicle 112. The charge port 134 may be electrically coupled to a charger or on-board power conversion module 132. The power conversion module 132 may condition the power supplied from the EVSE 138 to provide the proper voltage and current levels to the traction battery 124. The power conversion module 132 may interface with the EVSE 138 to coordinate the delivery of power to the vehicle 112. The EVSE connector 140 may have pins that mate with corresponding recesses of the charge port 134. Alternatively, various components described as being electrically coupled or connected may transfer power using a wireless inductive coupling.

One or more wheel brakes 144 may be provided for decelerating the vehicle 112 and preventing motion of the vehicle 112. The wheel brakes 144 may be hydraulically actuated, electrically actuated, or some combination thereof. The wheel brakes 144 may be a part of a brake system 150. The brake system 150 may include other components to operate the wheel brakes 144. For simplicity, the figure depicts a single connection between the brake system 150 and one of the wheel brakes 144. A connection between the brake system 150 and the other wheel brakes 144 is implied. The brake system 150 may include a controller to monitor and coordinate the brake system 150. The brake system 150 may monitor the brake components and control the wheel brakes 144 for vehicle deceleration. The brake system 150 may respond to driver commands and may also operate autonomously to implement features such as stability control. The controller of the brake system 150 may implement a method of applying a requested brake force when requested by another controller or sub-function.

Electronic modules in the vehicle 112 may communicate via one or more vehicle networks. The vehicle network may include a plurality of channels for communication. One channel of the vehicle network may be a serial bus such as a Controller Area Network (CAN). One of the channels of the vehicle network may include an Ethernet network defined by Institute of Electrical and Electronics Engineers (IEEE) 802 family of standards. Additional channels of the vehicle network may include discrete connections between modules and may include power signals from the auxiliary battery 130. Different signals may be transferred over different channels of the vehicle network. For example, video signals may be transferred over a high-speed channel (e.g., Ethernet) while control signals may be transferred over CAN or discrete signals. The vehicle network may include any hardware and software components that aid in transferring signals and data between modules. The vehicle network is not shown in FIG. 1 but it may be implied that the vehicle network may connect to any electronic module that is present in the vehicle 112. A vehicle system controller (VSC) 148 may be present to coordinate the operation of the various components.

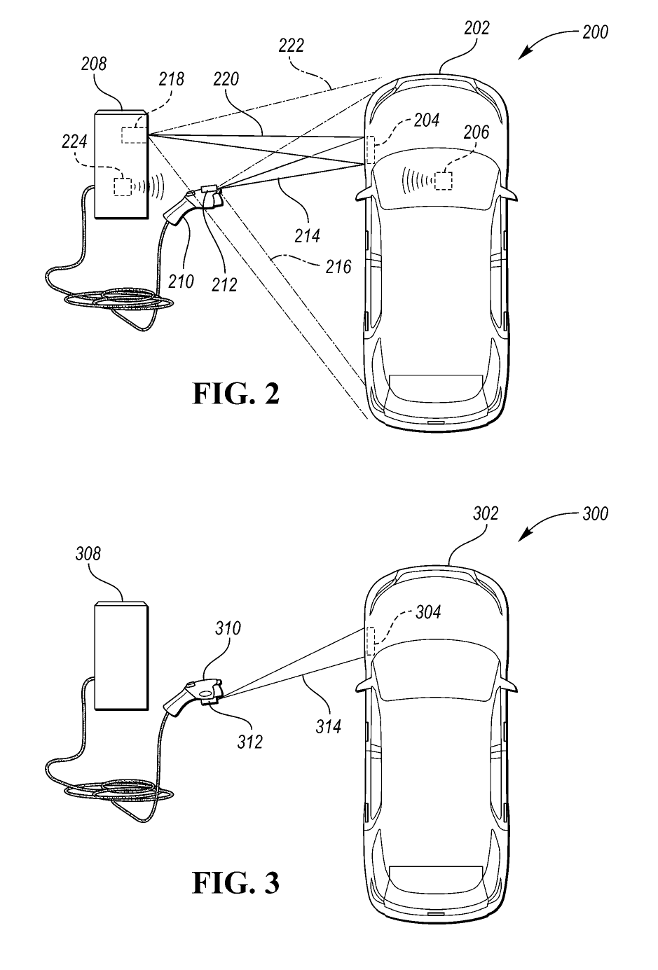

FIG. 2 is a top view illustration of an electric vehicle charge system 200 that captures an image of a vehicle 202 and projects information onto the vehicle 202. Here the vehicle 202 is a hybrid electric vehicle 202 that has a receptacle 204 to couple a traction battery of vehicle 202 with a charge station 208 also referred to as Electric Vehicle Supply Equipment (EVSE). In this illustration, the vehicle 202 also includes a wireless transceiver 206. The EVSE 208 includes a plug 210. The plug 210 may include visual unit 212 that may include a projection unit and/or a camera. The projection unit may be a projection/heads up display (HUD)system that may use a solid-state light source (e.g., a Light Emitting Diode (LED)) that projects light through a Liquid Crystal Display (LCD) screen to create an image when reflected off of a surface. The projection system also may use optical waveguides to produce images directly in a combiner rather than use a projection system. The system may use a scanning laser to display images or video imagery. New technologies may include micro-display imaging technologies including liquid crystal display (LCD), liquid crystal on silicon (LCoS), digital micro-mirrors (DMD), and organic light-emitting diode (OLED). The visual unit 212 may scan an area 216 capturing an image of a vehicle and after parsing the area 216, the controller may determine a location of the receptacle 204 based on a manufacturer, make and model that is determined by the controller from the image. The visual unit 212 then may activate the projection unit to project/illuminate an area 214 proximate to the receptacle 204. As the plug 210 may be in motion, during a time when the user removes the plug 210 from the EVSE 208, the visual unit 212 may be required to compensate for the relative position between the plug 210 and the receptacle 204. In one embodiment, the projection unit may adjust a translation, rotation, and elevation of the image projected 214 such that the text in messages displayed are generally horizontal and aligned with the receptacle. Also, the projection unit may change a focal length, focus, depth of field (DOF), or similar adjustment. If the plug 210 is facing in a direction such that the projection area 214 is not proximate to the receptacle 204, the controller may adjust the image to be an indicator of a direction of motion that the plug 210 must travel to reach the receptacle 204.

In another embodiment, the projection unit of the visual system 212 is fixed with respect to the plug 210 and the controller may then adjust the displayed image based on the camera view. In this embodiment, the controller may adjust the image to be an indicator of a direction of motion that the plug 210 must travel to reach the receptacle 204. Also, the displayed image may include an emphasis projected on a location of the receptacle 204 when a face of the plug 210 is in line with the receptacle 204.

Likewise, the EVSE 208 may include a visual system 218 that may scan an area 222 capturing an image of a vehicle and after parsing the area 222, the controller may determine a location of the receptacle 204 based on a manufacturer, make and model that is determined by the controller from the image. The visual unit 218 then may activate the projection unit to proj ect/illuminate an area 220 proximate to the receptacle 204. The projection unit may adjust a translation, rotation, and elevation of the image projected 220 such that the text in messages displayed are generally horizontal and aligned with the receptacle. The projection unit may also project in an area 220 that is offset from the receptacle 204 such that a message may be projected onto a relatively flat surface of the vehicle 202.

Further, the EVSE 208 may include a transceiver 224 to communicate with the transceiver 206 of the vehicle. This communication may include transmission and reception of a vehicle identification number (VIN), vehicle manufacturer, vehicle type, vehicle make, vehicle model, vehicle model year, or vehicle date of manufacture. That information when received by the EVSE 208 may allow the controller to configure the EVSE 208 for specifics of the vehicle 202. That data may then be used to generate the displayed image.

FIG. 3 is a top view illustration of an electric vehicle charge system 300 that projects information onto the vehicle 302. Here the vehicle 302 is a hybrid electric vehicle 302 that has a receptacle 304 to couple a traction battery of vehicle 302 with a charge station 308 also referred to as Electric Vehicle Supply Equipment (EVSE). In this illustration, the vehicle 302 may also include a wireless transceiver or a wireline transceiver. The EVSE 308 includes a plug 310. The plug 310 may include a projection unit 312 (e.g., a projection/heads up display (HUD) system). The plug 310 may include an accelerometer, GPS sensor, or other system to determine a position attitude (e.g., an orientation relative to Earth's horizon) of the plug 310. For example, when the plug is housed in the cradle, a position and attitude is known and that point may be considered a reference point. When the plug 310 is removed, data from the GPS/accelerometer to determine a relative position and attitude from the reference point. And based on that data, adjust an image to be displayed by the projection unit 312 such that the projected image 314 provides guidance to a user.

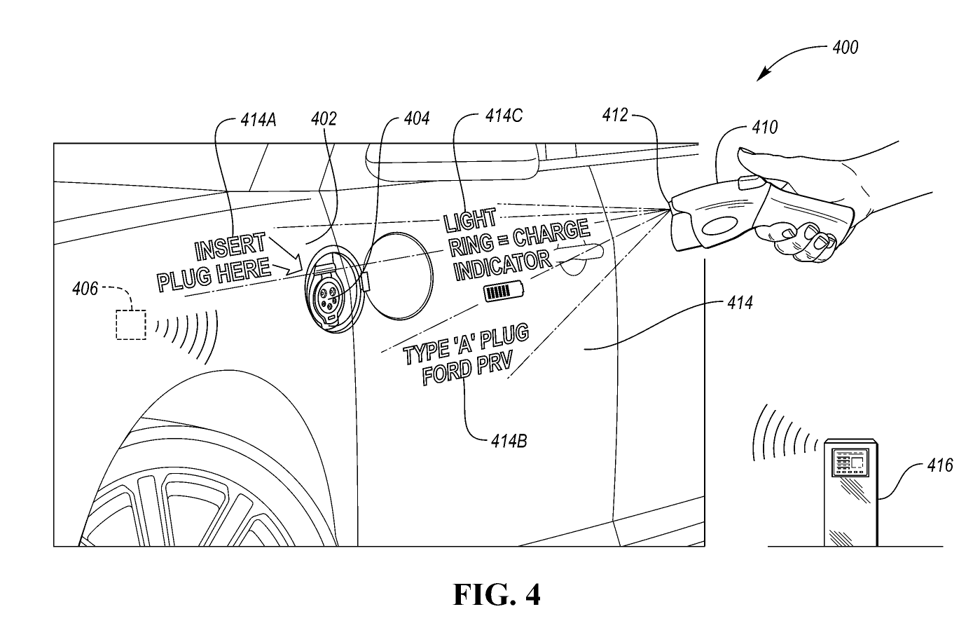

FIG. 4 is a perspective view illustration 400 of information projected from an electric vehicle charger onto a hybrid electric vehicle 402. The electric vehicle 402 includes an electric charge receptacle 404 and a wireless transceiver 406. In this illustration, the EVSE includes a plug 410 with a visual unit 412 configured to project an image 414 onto the vehicle 402. The image 414 may include a plug guide 414A that includes a highlighted or emphasis ring surrounding the receptacle 404, plug characteristics 414B (e.g., a plug type, a system power capability, a vehicle make, or model), and charge characteristics 414C such as a battery state of charge, a charge status (e.g., charging, waiting to charge, charged). The wireless transceiver 406 in the vehicle may communicate with a wireless transceiver 416 that is remote (e.g., a cellular tower, an area network, a nomadic device, a business/residence, or the charge station).

Control logic or functions performed by controller may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but are provided for ease of illustration and description. The control logic may be implemented primarily in software executed by a microprocessor-based vehicle, engine, and/or powertrain controller, such as controller. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as Read Only Memory (ROM) devices and information alterably stored on writeable storage media such as floppy disks, magnetic tapes, Compact Discs (CDs), Random Access Memory (RAM) devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An electric vehicle (EV) charge system comprising:
a plug;
a camera;
a projection unit; and
a controller configured to, responsive to receiving a charge request, activate the camera to capture an image of a vehicle, and project onto the vehicle guidance information associated with the plug based on a vehicle type and relative vehicle location identified from the image.

2. The charge system of claim 1, wherein the relative vehicle location is defined by a difference between a location of a receptacle for the plug on the vehicle and the charging system.

3. The charge system of claim 2, wherein the guidance information includes an outline of the vehicle accentuating the location of the receptacle or indicators directed to the location of the receptacle.

4. The charge system of claim 1, wherein the camera and the projection unit are housed in the plug.

5. The charge system of claim 4, wherein the relative vehicle location is defined by a difference between a location of a receptacle for the plug on the vehicle and the plug.

6. The charge system of claim 5, wherein the guidance information includes an outline of the vehicle accentuating the location of the receptacle or indicators directed to the location of the receptacle.

7. The charge system of claim 6, wherein the controller is further configured to adjust the guidance information based on the image such that when the image includes a location of the receptacle, the guidance information includes an emphasis of the location of the receptacle.

8. The charge system of claim 1 further comprising a wireless transceiver that is configured to communicate with a transceiver of the vehicle.

9. The charge system of claim 8, wherein the controller is further configured to receive from the transceiver, via the wireless transceiver, a property of a charge system of the vehicle, wherein the property includes a maximum charge current, a battery state of charge, a maximum voltage, or an estimated departure time, and cause the projection unit to project, onto the vehicle, the property.

10. The charge system of claim 9, wherein the controller is further configured to adjust a color of a light of the plug to match a color of a luminescent ring of a receptacle for the plug on the vehicle.

11. The charge system of claim 1, wherein the charge request includes an output from a switch on the plug or detection of removal of the plug from a cradle configured to hold the plug when not in use.

12. An alignment method for an electric vehicle charge station comprising:
by a controller, responsive to a charge request,
activating a camera to capture an image of a vehicle; and
causing a projection unit to project onto the vehicle guidance information associated with a plug of the charge station based on a vehicle type and relative vehicle location identified from the image.

13. The method of claim 12 further comprising, adjusting the guidance information based on the image such that when the image includes a location of a receptacle for the plug on the vehicle, the guidance information includes an emphasis of the location of the receptacle.

14. The method of claim 13, wherein the guidance information includes an outline of the vehicle accentuating the location of the receptacle or indicators directed to the location of the receptacle.

15. The method of claim 12 further comprising,
receiving, from a transceiver, a property of a charge system of the vehicle, wherein the property includes a maximum charge current, a battery state of charge, a maximum voltage, or an estimated departure time, and
causing the projection unit to project, onto the vehicle, the property.

16. A charge station for an electric vehicle comprising:
a plug;
a projection unit; and
a controller configured to, responsive to receiving a charge request and identification of a relative location of the vehicle to the charge station, cause the projection unit to project onto the vehicle guidance information associated with the plug.

17. The charge station of claim 16, wherein the relative location is defined by a difference between a location of a receptacle for the plug on the vehicle and the charge station.

18. The charge station of claim 17, wherein the guidance information includes an outline of the vehicle accentuating the location of the receptacle or indicators directed to the location of the receptacle.

19. The charge station of claim 16 further comprising a wireless transceiver that is configured to communicate with a transceiver of the vehicle.

20. The charge station of claim 19, wherein the controller is further configured to receive from the transceiver, via the wireless transceiver, a property of a charge system of the vehicle, wherein the property includes a maximum charge current, a battery state of charge, a maximum voltage, or an estimated departure time, and cause the projection unit to project, onto the vehicle, the property.
